(19) United States
(12) Patent Application Publication
(10) Pub. No.: US 2019/0270259 A1
(43) Pub. Date: Sep. 5, 2019

(54) A COMPOSITE SHEET MATERIAL AND A METHOD OF MANUFACTURE THEREOF

(71) Applicant: GPFONE LTD, London (GB)

(72) Inventor: ADAM GANS, London (GB)

(73) Assignee: GPFONE LTD., London (GB)

(21) Appl. No.: 16/319,143

(22) PCT Filed: Jul. 19, 2017
(86) PCT No.: PCT/GB2017/052134

§ 371 Date: Jan. 18, 2019

(30) Foreign Application Priority Data
Jul. 19, 2016 (GB) 1612539.5

(51) Int. Cl. B29C 70/08; B32B 5/02; B32B 15/08; B32B 15/14

(52) U.S. Cl. CPC B29C 70/088; B32B 5/022; B32B 5/024; B32B 15/08; B32B 2307/414; B32B 2262/106; B32B 2307/402; B32B 2307/41; B32B 2307/412; B32B 15/14

(57) ABSTRACT

A method of making a composite sheet material, comprising: applying (102) an opaque layer of opaque material (12), for example aluminium, to a first side of a layer of fibrous material (10); applying (104) a layer of transparent or translucent plastics material (14) on a side of the opaque material opposite the layer of fibrous material. The side of the layer of opaque material is viewable through the layer of plastics material. The opaque layer is a different colour to the colour of the fibrous material. The opaque layer and the layer of plastics material cooperate to provide the composite sheet material with a coloured appearance. The layer of opaque material is coated on the first side of the fibrous layer so that contours of the side of the opaque material correspond to the shape of the first side of the fibrous material layer.

### FIELD OF THE INVENTION

The invention relates to a colored composite sheet material and a method of manufacture of such a composite sheet material. The invention also relates to a colored composite structure including said composite sheet material, and a method of manufacture of such a structure.

### BACKGROUND

Composite materials, and in particular carbon fiber composites, are materials that are exceptionally popular due to their structural properties. Such materials have a high strength to weight ratio and are highly versatile. Composite materials are formed of a fibrous reinforcement material embedded within a matrix material. A common example is a woven carbon fiber mat embedded in an epoxy-based matrix. Carbon fiber composites are used extensively in high performance industries such as motorsport, aviation, industrial/wind, sporting goods, and high-end consumer products.

Many composite materials have a very distinctive appearance due to the woven structure of the fibrous reinforcement material. This appearance has become desirable due to its association with high-performance products formed of composite materials. However, the appearance of carbon fiber composite materials is currently restricted by the color of carbon fibers, which are naturally black due to the carbonization process used in its manufacture. The materials are therefore limited in their attractiveness to the creative industries.

Extensive work has been performed to produce composite materials with a bright color, while retaining the distinctive woven fiber appearance. With regard to carbon fiber, it is believed that there is no known way to chemically modify carbon fiber so that the carbon fiber is colored.

Various attempts have been made to produce woven carbon fiber fabric that appears colored. For example, colored yarn may be interwoven with the carbon fiber. The result is a blurred colored version of traditional carbon fiber. Alternatively, a carbon fiber part can be painted, as it is currently on F1 cars. However, the paint hides the woven appearance of the carbon fiber material.

Furthermore, paint can add substantial weight and cost to a product.

In a patent application filed by the applicant whose subject matter is disclosed in patent publication number WO2014181114, a process for the manufacture of a colored composite structure is described. This composite structure includes a layer of woven glass fibers-between a carbon fiber composite and a colored, translucent thermoplastic layer. The glass fibers have a white or silver colored natural state, providing a bright backing for the thermoplastic layer. The woven glass fibers are not however as lightweight as carbon fibers, nor do they provide as much mechanical stiffness and strength to the structure as carbon fibers. Essentially the woven glass fibers would represent an intermediate layer provided to avoid having a black background to the thermoplastic layer. Therefore, the coated carbon fiber option can be considered the preferred option.

Furthermore, the patent application filed by the applicant whose subject matter is disclosed in patent publication number WO2014181114, describes a manufacturing process that employs relatively low temperatures and, as a result, relatively long cure cycles, to cure the parts. This approach may be acceptable for large parts produced in very small quantities in order to reduce energy costs. However, the cure cycles are too long for conventional parts for automotive, industrial, and sporting goods applications where large volumes require much shorter cure cycles.

An object of the present invention to address the above-mentioned issues.

### SUMMARY OF THE INVENTION

In accordance with a first aspect of the present invention, there is provided a method of making a composite sheet material, comprising: applying an opaque layer of opaque material to a first side of a layer of fibrous material; applying a layer of transparent or translucent plastics material on a side of the opaque material opposite the layer of fibrous material, wherein the side of the layer of opaque material is viewable through the layer of plastics material, and wherein the opaque layer is a different color to the color of the fibrous material, and the opaque layer and the layer of plastics material cooperate to provide the composite sheet material with a coloured appearance, wherein the layer of opaque material is coated on the first side of the fibrous layer so that contours of the side of the opaque material correspond to the shape of the first side of the fibrous material layer.

As well as addressing the issues mentioned above, the opaque layer advantageously increases strength, reducing a likelihood of the transparent or translucent plastics material cracking.

The plastics material may be a thermoplastic material. Alternatively, the plastics material may be a thermoset material.

The applying the layer of opaque material may be performed by vapor deposition of the opaque material onto the first side of the layer of fibrous material. Alternatively, the layer of opaque material may be applied by laminating a thin foil onto the fibrous material.

There is further provided a method of making a composite structure, comprising: said method of making a composite sheet material; adhering a pre-preg to a second side of the layer of fibrous material; and curing and/or forming the pre-preg and the composite sheet material to form the composite structure. The adhering the pre-preg preferably take place while the composite sheet material is in the mold.

The method may comprise a prior step before the adhering of forming the composite sheet material into a required shape, for example against a surface of a mold.

The plastics material of the transparent or translucent layer may be a thermoplastic, and in this case the composite sheet material may be formed in a mold before the pre-preg is adhered. The forming of the composite sheet material may include softening the composite sheet material above the vicat softening point of the thermoplastic to facilitate shaping. For example, the forming temperature may be greater than 160° C. and less than 300° C., preferably less than 200° C. The plastics material of the transparent or translucent layer may be a thermoset, and in this case the plastics material may be partially cured or uncured when located in the mold and may then be fully cured.

Where the composite sheet material is formed/cured before the pre-preg is adhered, the method may further comprise: before adhering the pre-preg to the second side of the layer of fibrous material, a step of inspecting the formed composite sheet material for defects; and if no defects are present, adhering the pre-preg to the second side of the layer of fibrous material.

The composite structure may be planar. Alternatively, the composite structure may be non-planar, in particular tubular. In this case, the composite sheet material has a pair of longitudinal edges, and the method may further comprise: locating the pre-preg circumferentially around an elongate tool, wherein the adhering the pre-preg to the second side of the layer of fibrous material comprises adhering the composite sheet material over the pre-preg, wherein the composite sheet material is shaped so that the longitudinal edges are located close together when the composite sheet material is located over the pre-preg, wherein, during the curing and/or the longitudinal edges are close together such that after curing or forming the transparent or translucent material at the longitudinal edges is fused together.

Where the composite structure is tubular, the composite sheet material may be shaped so that the longitudinal edges overlap. In this case, the transparent or translucent layer preferably softens during curing such so the longitudinal edges fuse together in such a way that the join is substantially invisible.

In any of the methods of making a composite structure mentioned above, planar or otherwise, the pre-preg may be a thermoset pre-preg. In this case, the curing is performed at a temperature of at least 85° C. and less than 165° C., preferably less than 150° C.

The plastics material layer may also be a thermoset layer. In this case the curing is also performed at a temperature of at least 85° C. and less than 165° C., preferably less than 150° C.

Alternatively, the pre-preg may be a thermoplastic pre-preg and also the plastic material layer may be thermoplastic material. In this case, the forming of both the thermoplastic pre-preg and also the plastic material layer may be performed together at a temperature from 160° C. to 300° C., preferably less than 220° C., preferably still less than 200° C.

However, the plastics material layer may be thermoplastic material while the pre-preg is a thermoset pre-preg. In this case, the curing of the thermoset pre-preg may preferably be performed at a temperature that does not exceed a vicat softening point of the thermoplastic material.

According to a second aspect of the present invention, there is provided a composite sheet material comprising: a layer of fibrous material, a layer of opaque material and a layer of transparent or translucent plastics material, wherein a first side of the layer of opaque material is coupled to a first side of a layer of fibrous material and the layer of plastics material is located against a second side of the layer of opaque material, wherein the second side of the layer of opaque material is viewable through the layer of plastics material, and wherein the opaque layer is a different color to the color of the fibrous material and the opaque layer and the layer of plastics material cooperate to provide the composite sheet material with a colored appearance, wherein the first side of the layer of fibrous material is textured and contours of the second side of the opaque material correspond to the shape of the first side of the layer of fibrous material. The plastics material may be a thermoset material and may be partially or wholly cured.

There is further provided a composite structure comprising: said composite sheet material of the second or third aspect; and a composite material adhered to a second side of the woven carbon fiber material, wherein the composite material has been located against the second side as a pre-preg material and the composite material and the composite sheet material have been cured and/or formed together to form the composite structure. The composite structure may be tubular.

According to a fourth aspect of the present invention, there is provided a method of making a composite structure, comprising: adhering a pre-preg to a composite sheet material, wherein the composite sheet material comprises the composite sheet material of the second aspect, wherein the adhering is to a second side of the fibrous layer, and curing and/or forming the pre-preg and the composite sheet material to form the composite structure.

The composite sheet material may be the composite sheet material according to the second or third aspect of the invention.

There may be provided a method of making a composite structure, wherein the composite structure is non-planar, comprising: the method of the third aspect defined above, wherein the composite sheet material has a pair of longitudinal edges; and locating the pre-preg circumferentially around an elongate tool. The adhering the pre-preg to the second side of the layer of fibrous material may comprise adhering the composite sheet material over the pre-preg, wherein the composite sheet material is shaped so that the longitudinal edges are located close together. The curing and/or forming may comprise curing and/or forming the composite sheet material and the pre-preg, wherein the longitudinal edges are close together during the curing and/or forming so that after curing or forming the transparent or translucent material at the longitudinal edges are fused together.

The composite sheet material may be shaped so that the longitudinal edges overlap, wherein the transparent or translucent layer softens during curing such that the longitudinal edges fuse together without any join being substantially visible.

The pre-preg may be a thermoset pre-preg. In this case, the curing is performed at a temperature of at least 85° C. and less than 165° C., preferably less than 150° C.

The pre-preg may be a thermoplastic pre-preg and the plastic material layer may be a thermoplastic material. In this case, the curing and forming may be performed at a temperature from 160° C. to 220° C., preferably less than 200° C.

The plastics material layer may be formed of thermoplastic material. Where the pre-preg is a thermoset pre-preg, the curing of the thermoset pre-preg is preferably performed at a temperature that does not exceed a softening point of the thermoplastic material.

In any aspect of the invention, the opaque layer may be a metal layer, preferably a single element metal layer, preferably consisting of one of: aluminium, nickel, chromium, tin, indium, silver, gold and platinum. The opaque layer may be less than 100 nanometres in thickness. The opaque layer may be greater than 10 nanometres in thickness.

In any aspect of the invention, the layer of plastics material is preferably translucent and colored.

In any aspect of the invention, the fibrous material is preferably a woven fibrous material or a non-woven sheet of unidirectional fibers. The fibrous material may comprise one or more of: carbon fiber, fiberglass, polypropylene, aramid and boron. Individual tows in the woven fibrous material may be comprised entirely of fiber or be stabilized by some form of agent. Alternatively, the tows may be impregnated by a thermoplastic or thermoset resin prior to weaving. Where the tows are impregnated, thermoplastic resin is preferred due to its inherent non-tacky nature.

In any aspect of the invention, the pre-preg may be a thermoset or thermoplastic carbon fiber pre-preg.

### BRIEF DESCRIPTION OF THE FIGURES

For better understanding of the present invention, embodiments will now be described, by way of example only, with reference to the accompanying Figures in which:

FIG. 1 is an illustrative cross-sectional view of a coloured carbon fiber composite sheet; and

FIG. 2 is flowchart indicating steps in a process of manufacturing a composite sheet material in accordance with an embodiment;

FIG. 3 is a flowchart indicating steps in a process of manufacturing a composite sheet material in accordance with another embodiment;

FIG. 4 is a flowchart indicating steps in a process of manufacturing a composite sheet material in accordance with another embodiment; and

FIG. 5 is a flowchart indicating steps in a process of manufacturing a composite sheet material in accordance with another embodiment.

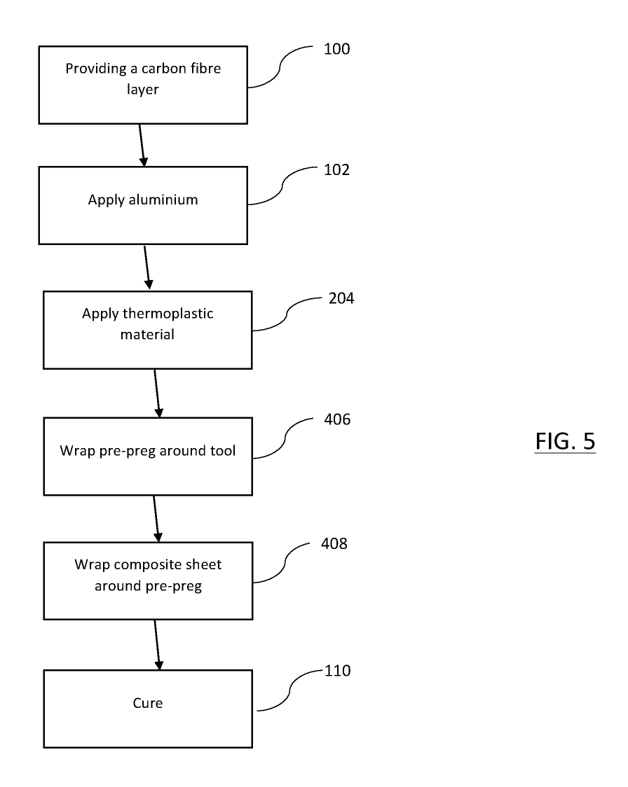

### DETAILED DESCRIPTION OF EMBODIMENTS

Like steps are denoted by like reference numerals throughout.

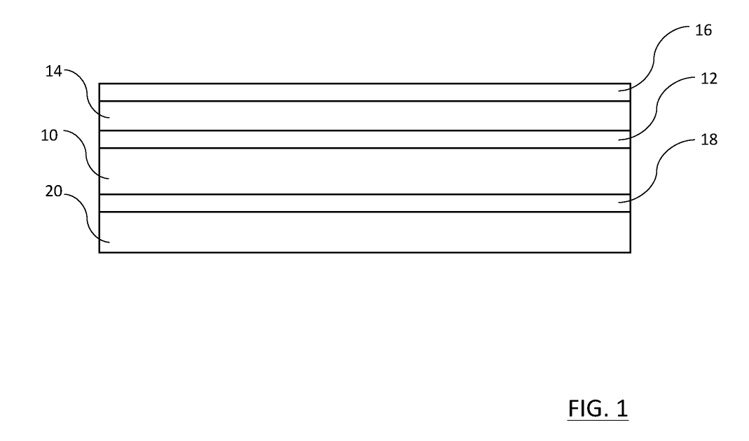

Various carbon fiber composite structures and their manufacture will be described in the following, in accordance with different embodiments of the invention. In FIG. 1 a cross-sectional view of a colored carbon fiber composite sheet is illustrated, which retains the structural qualities of conventional carbon fiber composites but provides a high-quality colored appearance. The illustration of FIG. 1 will be used in the description of several different embodiments.

The composite sheet includes a carbon fiber layer 10, an aluminium layer 12 and a translucent layer 14. A first side of the aluminium layer 12 is located on a first side of the carbon fiber layer 10. A first side of the translucent layer 14 is located against a second side of the aluminium layer 12, opposite to the carbon fiber layer 10. A protective finish layer 16 is located on a second side of the translucent layer 14, opposite to the aluminium layer 12, providing an exterior viewing face.

A composite layer 20 is bonded to a second side of the carbon fiber layer 10 by a layer of adhesive film 18. The composite layer 20 is in order to produce composite parts or structures using the composite sheet material as an outer.

The carbon fibre layer 10 is formed of woven carbon fiber filaments. The carbon fiber may be woven into a twill (e.g. 2/2), satin or plain or other kind of weave. Alternatively, the carbon fiber may be a unidirectional non-woven fabric.

The aluminium layer 12 provides a bright, neutral backing color viewable through the translucent layer 14. The translucent layer 14 may be colored. The translucent layer 14 and the aluminium layer 12 cooperate to provide a color to the composite sheet, which is different to the color of the woven carbon fiber. Where the translucent layer 14 is clear, the overall color of the composite material is the color of aluminium, that is, silver. In embodiments, rather than being translucent, the layer 14 may be transparent.

Although FIG. 1 suggests that the aluminium layer 12 is a planar layer located on a planar surface of the carbon fiber layer 10, in practice this will not be the case as the surface of the carbon fiber layer 10 is textured. The aluminium layer 12 is in the form of a thin coating, and the contours or patterns of the fibers of the underlying carbon fiber layer 10 can be clearly seen. This results in the composite material having a highly distinctive appearance. Preferably, the aluminium layer is greater than 10 nanometres in thickness. Preferably the aluminium layer is less than 100 nanometres in thickness. Since the aluminium layer 12 is very thin, it adds little to the weight and volume of the composite sheet. The aluminium also usefully does not deform on heating during the forming/curing processes.

The translucent layer 14 is formed of thermoplastic material. The color of the translucent layer 14 may be present as an inherent characteristic of the particular thermoplastic, or be provided by addition of a pigment to a thermoplastic resin, for example. Embodiments of the invention are not limited to any particular way in which the translucent layer is colored. The thermoplastic may be thermoplastic polyurethane (TPU), for example. As well as cooperating with the aluminium layer to provide color, the translucent layer 14 serves to protect the aluminium layer 12.

The finish layer 16 provides an aesthetically improved finish and increases the hardness of the exterior surface. Typically, the finish layer 16 is a lacquer such as polyurethane. In variant embodiments, the finish layer 16 is omitted.

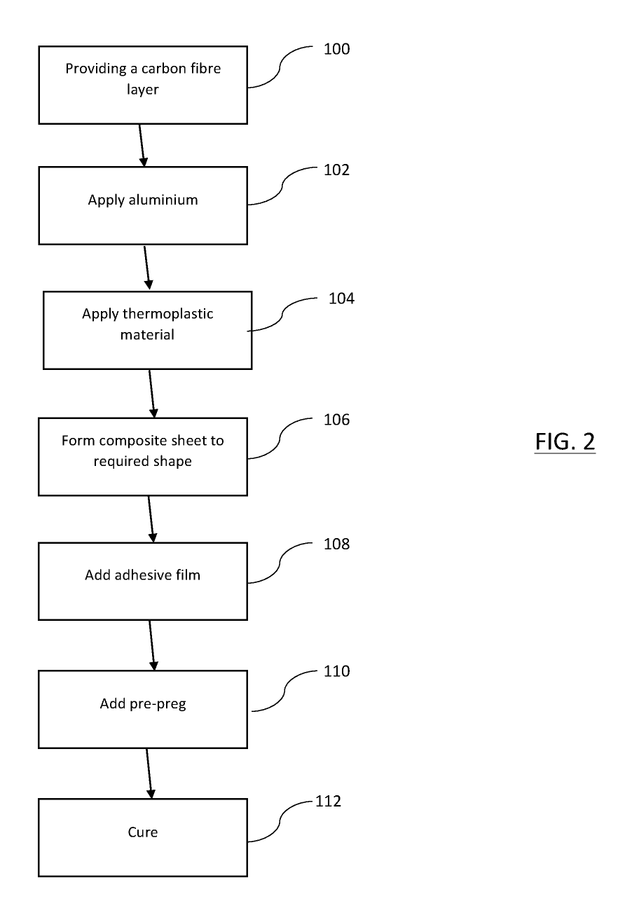

Production of the composite sheet material and then a composite structure incorporating the composite sheet material will now be described according to a first production process. Referring to FIG. 2, at step 100 the carbon fiber layer 10 is provided. The carbon fiber layer 10 is woven, for example in a twill weave, or formed of a unidirectional non-woven fabric, in a way that is known in the art.

At step 102, the aluminium layer 12 is then applied to the carbon fiber layer 10 by vapor deposition. In the vapor deposition, the carbon fiber layer 10 is passed over a source of gaseous aluminium and the gaseous aluminium condenses on the first side of the carbon fiber layer 10, for example using a roll-to-roll web system. The amount of aluminium deposited can be precisely controlled, for example by controlling the speed at which the carbon fiber layer 10 is passed over the source, amongst other factors.

The translucent layer 14 is applied using a filming and laminating process at step 104. In this process thermoplastic is extruded into a film, and then heated and pressed onto the second side of the aluminium layer 12. The film is preferably from 0.1 mm to 10 mm in thickness, preferably still from 0.25 mm to 0.3 mm.

The composite sheet is then formed into a required shape at step 106 by laying the composite sheet in a mold. The composite sheet may also be cut before being put into the mold. The composite sheet may be thermoformed into the required shape using heat and/or vacuum to ensure a good fit with the mold and the required surface finish. For example, the composite sheet may be heated to 150° C. to soften the thermoplastic layer 14 and enable formation into the required shape. An intensifier, for example a silicon mandrel or match-molded component, may be utilized to compress the composite against the mold in order to obtain the required conformity against the surface of the mold. If a planar shape is required, step 106 may be omitted.

To form the composite structure, at step 108 the adhesive film 18 is adhered to the second side of the carbon fiber layer 10. At step 110 a layer of uncured composite material in the form of carbon fiber thermoset pre-preg is laid up over the composite sheet and adhered to the composite sheet with the adhesive film 18. The carbon fiber thermoset pre-preg comprises carbon fiber reinforcement, which may be a woven carbon fiber fabric or may be in a unidirectional non-woven form, and a thermoset resin such as epoxy resin. Typically, the pre-preg is in a B-stage, partially cured form, when it is laminated on top of the composite sheet. In this case, since the B-stage pre-preg is only partially cured, it remains tacky. In some cases, the tacky surface of the pre-preg will allow omission of the adhesive film 18 during the lamination process meaning that step 108 is omitted. A continuous bond between the thermoset pre-preg and the second side of the carbon fiber layer 10 is achieved using a conventional lamination/lay-up and shaping technique. The end-result is a composite “pre-form” ready for curing.

At step 112, the pre-form is then cured in the mold using heat and/or a vacuum in accordance with known techniques, to form a cured composite piece. The curing temperature in the mold is preferably below the softening point of the material of the thermoplastic layer, so that thickness of the thermoplastic layer 14 is maintained. The curing is performed at a temperature greater than 85° C., which may be greater than 100° C. The curing is performed at a temperature less than 155° C., which may be less than 135° C. Generally, the higher the temperature, the shorter the curing time needed and the precise temperatures and pressures defined may depend on the particular carbon fiber pre-preg that is used. At 155° C., the composite material may be heated for 5 to 30 minutes to result in the composite piece. At 85° C., the heating may be for 8 hours. The pressure applied is typically 1 bar to 10 bars.

It is mentioned above that the composite sheet may be heated, for example, to 150° C., to soften the thermoplastic layer 14 and enable formation into another shape. However, the composite sheet may be heated to a higher temperature. In optional additional steps taking place after step 106 and before steps 108 and 110, a two-step heating process may be used in which the composite sheet is heated in the mold to at least 150° C., preferably at least 160° C., and possibly at least 180° C. and preferably below 220° C., possibly below 200° C., so that the composite sheet softens substantially and a new shape can be achieved. The composite sheet may then be cooled down to an ambient temperature and removed from the mold and inspected. In the event of imperfections in the thermoformed composite sheet, the composite sheet can be discarded. The imperfections may be cosmetic, for example flaws viewable from the exterior side of the translucent layer 14. Such flaws might be, for example, damage to the aluminium layer 12 or the translucent layer 14, which render the composite sheet unsuitable for continued production. The imperfections may also be structural. Discarding the composite sheet at this stage means that subsequent steps are not performed and no additional material used in sub-layers is wasted. If the formed composite sheet is acceptable, that is, there are no imperfections meaning that the sheet should be discarded, the sheet is returned to the mold (or put into another mold), and the production process continues at step 108.

In another embodiment, instead of the translucent layer 14 of the composite structure being formed of thermoplastic material, the translucent layer 14 is formed of thermoset plastic material.

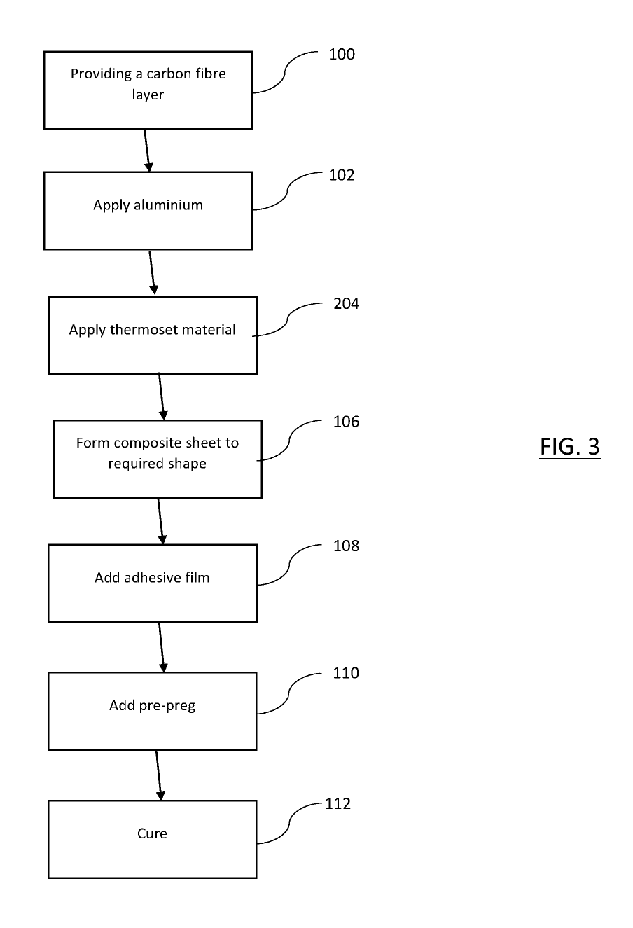

Referring to FIG. 3, in step 204 the translucent layer 14 is applied using a high precision filming and laminating process in which thermoset resin is extruded into a film, and then heated and pressed onto the second side of the aluminium layer 12. The film is preferably from 0.1 mm to 10 mm in thickness, preferably still from 0.25 mm to 0.3 mm. In general, same or similar laminating conditions may be used as in embodiments in which the layer 14 is formed of thermoplastic. However, temperatures are generally lower.

The thermoset translucent layer 14 is partially cured after being laminated onto the aluminium layer 12, that is, is at B-stage. This is due to the thermoset material having already been heated during the lamination process. The partially cured thermoset layer 14 may, for example be 30-40% cured. The thermoset layer being partially cured before being laid up in the mould is advantageous in that the surface of the thermoset layer 14 is tacky and can easily be placed in the mold. Also, the composite sheet is more stable for handling and the time required to cure the thermoset layer in the mold is reduced.

In practice, such composite sheets with the partially cured pre-preg may be made by one party and then supplied to another. That other party may then perform the subsequent steps in the production process.

In some embodiments, an additive may usefully be added to the thermoset translucent layer 14 to increase the viscosity of the thermoset translucent layer 14 during curing, such that the viscosity of the thermoset material of the translucent layer 14 is greater than a threshold viscosity. The thermoset material better maintains its thickness where such an additive is used.

The pre-preg making up the composite layer 20 that is applied to the second side of the carbon fiber layer 10 in step 110 may be a B-stage thermoset pre-preg. In this case, advantageously the curing conditions required may be very similar or the same as those required to cure the B-stage thermoset material of the translucent layer 14. Where the additive is used to increase viscosity of the thermoset material of the translucent layer 14, the viscosity of thermoset material in the pre-preg is preferably less than the viscosity of the thermoset material of the translucent layer 14, so that the thermoset material of the pre-preg of the composite layer 20 flows during curing but that of the translucent layer 14 substantially does not.

In other embodiments, instead of using an additive to change viscosity of the thermoset material of the translucent layer 14, the curing conditions may be configured to restrict flow.

In a variant embodiment, a thermoplastic pre-preg may be applied to the second side of the carbon fiber layer 10 instead of a thermoset pre-preg. As described above, the viscosity of the thermoset material of the translucent layer 14 may be modified or flow restricted in view of curing conditions.

In variant embodiments, a similar two-step process to that described above may be performed to enable the composite sheet material to be inspected before the pre-preg of layer 20 is added in step 110. In this case, the composite sheet including the translucent layer 14 of thermoset material is laid up in a mold and the composite sheet is fully cured. The composite sheet is then removed from the mold and inspected for flaws. Provided the composite sheet is acceptable, the composite sheet is then returned to the mold and the pre-preg (thermoset or thermoplastic) is added to the second side of the carbon fiber layer 10 to form the composite layer 20 and the pre-preg is cured or formed in the mold. In a variant, the cured composite sheet may be located in a different mold after being removed, and the pre-preg cured or formed in that mold.

In another embodiment, the translucent layer 14 of the composite structure is formed of thermoplastic material like in the embodiment described with reference to FIG. 2. In this other embodiment the carbon fiber pre-preg 20 is a thermoplastic pre-preg instead of thermoset pre-preg.

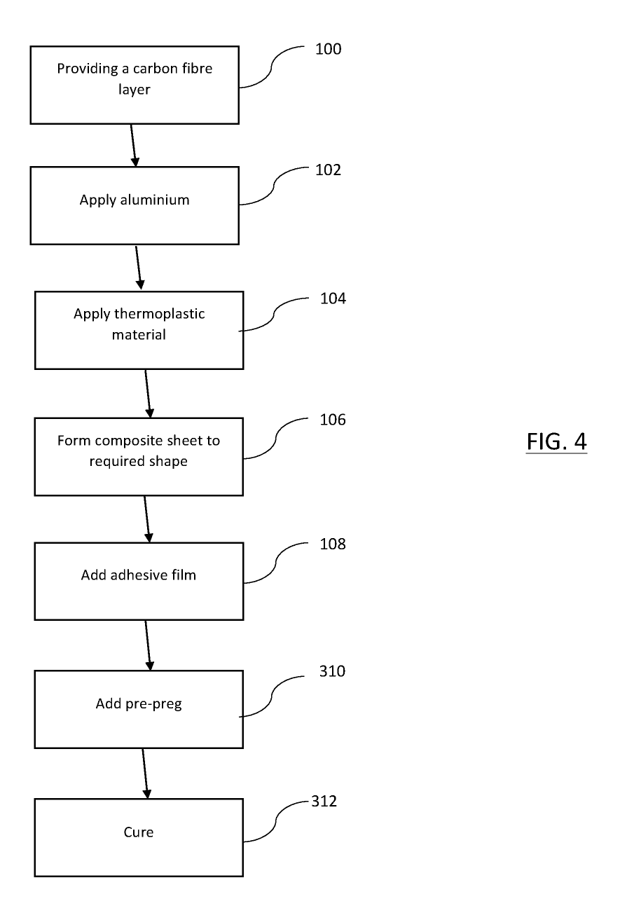

Referring to FIG. 4, in step 310 a carbon fiber thermoplastic pre-preg 20 is laid up over the composite sheet. Also, in step 312, the composite sheet and the carbon fiber pre-preg of composite layer 20 are formed at a temperature greater than 160° C. The forming temperature is less than greater 220° C., preferably less than 200° C. An absence of thermoset material in favor of thermoplastic material allows a higher forming temperature to be used, resulting in a faster cycle for parts. The forming cycle will be driven by the ability of the press to apply heat up the parts, and is preferably at least one minute and less than 30 minutes. The length of the forming cycle is dependent on the melting temperature and the particular thermoplastic material or materials used.

In a preferred embodiment, the type of thermoplastic used for the translucent layer 14 is the same as the thermoplastic used in the pre-preg, for example TPU (thermoplastic polyurethane). In this case, the same forming conditions are appropriate for both these parts of the composite structure.

While the thermoplastic pre-preg of composite layer 20 and the thermoplastic material of the translucent layer 14 may be formed in the same forming step in a mold, a similar two-step process to that described above may be performed to enable the composite sheet material to be formed and inspected before the pre-preg of layer 20 is added in step 110. In this case, the composite sheet is first formed in a first step of applying heat and pressure, inspected for flaws, and then the steps 310 and 312 performed. The temperatures used are typically in the ranges for forming thermoplastics mentioned above, e.g. 160-220° C.

In another embodiment, a tubular structure is formed of composite sheet material having the cross-section illustrated in FIG. 1. The translucent layer 14 is formed of thermoset plastic. To produce the tube, first a composite sheet is made as described with respect to FIG. 3 in steps 100, 102 and 204, where the thermoset plastic is partially cured, that is, at B-stage.

A carbon fiber thermoset pre-preg is then wrapped around a mandrel at step 406. This is done by winding carbon fiber sheets pre-impregnated with thermoset resin around the mandrel. The tacky nature of the pre-preg helps hold down the material onto the mandrel during the wrapping process.

Alternatively, dry carbon fiber filaments or fabrics may be wrapped around the mandrel and impregnated with thermoset resin in a secondary step.

The colored composite sheet is then wrapped around the mandrel, over the pre-preg at step 408. Longitudinal edges of the composite sheet are then adjacent or slightly overlapped. The composite sheet may be cut before being wrapped around, or after. The composite sheet may be heated to soften the translucent layer 14 to facilitate wrapping, for example the composite sheet may be heated to 50° C. An adhesive may be applied to the second side of the carbon fiber layer 10, although the tackiness of the thermoset resin may render this unnecessary. Preferably, the longitudinal edges of the composite sheet overlap by 0 mm and no more than 2 mm.

After the composite sheet has been wrapped around the mandrel, the mandrel with the composite sheet wrapped around is put into a corresponding female mold or otherwise contained, for example with plastic OPP (oriented polypropylene) tape. The mandrel is then heated and the composite sheet and the pre-preg are fully cured at step 410, with the temperature being in the same ranges as at step 112. The translucent layer 14 softens and the longitudinal edges fuse together such that there is no or little visible join between the two longitudinal edges.

The tubular structure may be a cylindrical tube or have another kind of tubular cross-section. A similar method may be used to make composite structures having other shapes.

In all the embodiments described above, after the composite structure has been cured and removed from any mold or autoclave, the finish coating 16 may then be applied to the exterior surface of the translucent layer 14 in an additional step. In variant embodiments however, the finish coating 16 may be omitted and thus this step omitted.

Various modifications may be made to the embodiments described above.

In the carbon fiber layer 10, the carbon fiber may be mixed or interwoven with other kinds of fibrous material, such as glass fibers, aramid, polypropylene or boron. In alternative embodiments that may be preferred for certain applications, the layer 10 may not be formed of carbon fibers, but instead alternative fibrous material, such as glass fibers, polypropylene, aramid or boron. The layer 10 may include a combination of two or more kinds of fibrous material such as carbon fiber, aramid, fiber glass, polypropylene and boron. The layer 10, whether including or excluding carbon fiber, may be formed of a fibrous mat including short fibers of any one or more of these fibrous materials or unidirectional non-woven fiber.

In alternative embodiments, the layer 12 may be formed of an opaque material other than aluminium, preferably but not necessarily a single element metal layer. For example, the layer may be formed of one of: nickel, chromium, tin, indium, silver, gold and platinum. Like aluminium, materials of color different to aluminium will cooperate with the translucent material to give the composite sheet a color when an exterior face of the translucent layer 14 is viewed. Such metals can be applied to the fibrous layer 10 using vapor deposition techniques.

In variant embodiments, the aluminium layer 12 can be otherwise applied to the first side of the carbon fiber layer 10. The aluminium layer 12, or alternatively a layer of any of the mentioned metals, could be applied by anodization. It may also be possible to apply the aluminium or other metal layer 12 while retaining the distinctive appearance of the underlying fibrous material by providing a thin foil and applying an adhesive layer to the first side of the foil and then pressing that side tightly against the first side of the carbon fiber layer 10, for example by applying high air pressure against the second side of the foil. Metal particles may alternatively be sprayed onto the first side of the carbon fiber material 10. Embodiments of the invention are not limited to any particular way in which the aluminium, or in variant embodiments other metal or material, is applied.

The pre-preg of layer 20 need not be carbon fiber pre-preg, but instead may be another kind of fibrous reinforcement pre-impregnated with a resin. For example, the fibrous reinforcement may be aramid, polypropylene, boron or fiberglass. The fibrous reinforcement may be a combination of fibrous materials, which may include one or more of carbon fiber, fiberglass, polypropylene, boron and aramid. Common resins for thermoplastic pre-pregs include TPU, PP, PET, PE, PPS, and PEEK. A common resin for thermoset pre-preg is epoxy resin. Other thermoset and thermoplastic resins are known in the art.

Where the selected pre-preg is adhesive by its nature and bonds to the composite sheet during the curing step, it may not be necessary to include the adhesive layer 18. In this case, the adhesive layer 18 and thus the step 110 of applying the adhesive layer 18 may be omitted. For example, where the carbon fiber pre-preg is impregnated with an epoxy resin, the adhesive layer 18 may be omitted.

The composite structures made according to the above described processes retain the structural qualities of conventional carbon fiber composites, but provide a high-quality colored appearance.

During curing at certain temperatures the pre-preg from which the composite layer 20 is made may transfer through the fibrous layer 10. The presence of the aluminium layer prevents color degradation from this. However, transfer of the pre-preg into the fibrous layer 10 may also advantageously increase the mechanical strength of the composite structure and is thus desirable.

Also, in the absence of the aluminium layer 12, material of the translucent layer 14 material of the layer 14 may transfer during forming or curing, also resulting in color degradation. The aluminium layer 12 prevents this.

Use of thermoplastic or thermoset material to form the translucent layer 14, and use of thermoplastic or thermoset pre-preg in the layer 20 depends on the particular application. Use of thermoset pre-preg has an advantage over use of thermoplastic pre-preg since thermoset resin is tacky and can be easily adhered to a second side of the carbon fie fiber layer 10, meaning that need the adhesive layer 18 can often be omitted. Cured thermoset also typically has better mechanical properties than formed thermoplastic. However, use of thermoplastic only in the composite structure has an advantage since where only thermoplastic is present the composite structure can be formed faster at a higher temperature. Also, as there is no chemical reaction when thermoplastic is used, undesirable by products are not produced. Also, where thermoplastic is used in the translucent layer 14, the thickness of that layer is typically better maintained in the finished composite structure. Since variation in thickness causes darker and lighter patches in the color of the translucent layer 14, use of thermoplastic material in the layer 14 may result in a better appearance than use of thermoset material.

Herein it should be understood that where the composite structure includes a thermoset composite layer 20 and/or the translucent layer 14 is formed of thermoset material, a curing step is required. Where thermoplastic is used in the pre-preg or in the translucent layer 14, this is formed rather than cured. Use of the words “form” and “cure” should be construed accordingly in context. The forming and/or curing steps described above may be performed in an autoclave. Alternatively, they may be performed using an out-of-autoclave process. For example, a resin transfer molding (RTM) process may be used. A hot press may also be used. Also, a vacuum infusion process may be used. The steps of shaping the composite sheet, where the structure is to be non-planar, and of forming and/or curing may be performed using other known processes.

Although outside the scope of the present claims, the processes mentioned above may be modified to exclude the opaque layer, which may be the aluminium layer, from the composite sheet material.

In this case, the translucent or transparent layer may be formed or cured directly onto the woven fiber. Some novel and advantageous composite sheet materials and structures may result from the processes mentioned above despite absence of the opaque layer.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A method of making a composite sheet material, comprising:
applying an opaque layer of opaque material to a first side of a layer of fibrous material;
applying a layer of transparent or translucent plastics material on a side of the opaque material opposite the layer of fibrous material, wherein the fibrous material is selected from a group consisting essentially of: carbon fibers, fiberglass, aramid, polypropylene and boron,
wherein the side of the layer of opaque material is viewable through the layer of plastics material, and
wherein the opaque layer is a different color to the color of the fibrous material, and the opaque layer and the layer of plastics material cooperate to provide the composite sheet material with a colored appearance, and
wherein the layer of opaque material is coated on the first side of the fibrous layer so that contours of the side of the opaque material correspond to the shape of the first side of the fibrous material layer.

2. The method of making a composite sheet material of claim 1, wherein the plastics material is a thermoplastic material or a thermoset material.

3. The method of making a composite sheet material of claim 1, wherein the opaque layer consists of one of: aluminum, nickel, chromium, tin, indium, silver, gold and platinum.

4. (canceled)

5. (canceled)

6. The method of making a composite sheet material of claim 1, wherein the applying the opaque layer of opaque material is performed by vapor deposition of the opaque material onto the first side of the layer of fibrous material.

7. The method of claim 1, wherein the plastics material is a thermoset material, and after the applying of the thermoset material, the thermoset material is partially cured.

8. The method of making a composite sheet material of claim 1, wherein the layer of plastics material is translucent and colored.

9. (canceled)

10. A method of making a composite structure, comprising:
the method of claim 1;
adhering a pre-preg to a second side of the layer of fibrous material; and
curing and/or forming the pre-preg and the composite sheet material to form the composite structure.

11. The method of claim 10, wherein the plastics material of the transparent or translucent layer is a thermoplastic, the method further comprising shaping the composite sheet material into a required shape, wherein the shaping includes softening the composite sheet material above the softening point of the thermoplastic.

12. The method of claim 10, further comprising:
before the adhering of the pre-preg to the second side of the layer of fibrous material, forming or curing the composite sheet material;
inspecting the formed or cured composite sheet material for defects;
if no defects are present, then performing the adhering of the pre-preg to the second side of the layer of fibrous material, and curing or forming the pre-preg with the composite sheet material adhered.

13. A method of claim 11, wherein the composite structure is tubular and wherein the composite sheet material has a pair of longitudinal edges, comprising:
locating the pre-preg circumferentially around an elongate tool,
wherein the adhering the pre-preg to the second side of the layer of fibrous material comprises adhering the composite sheet material over the pre-preg, wherein the composite sheet material is shaped so that the longitudinal edges are located close together when the composite sheet material is located over the pre-preg,
wherein, during the curing and/or forming the longitudinal edges are close together such that after curing or forming the transparent or translucent material at the longitudinal edges is fused together.

14. The method of making a composite structure of claim 13, wherein the composite sheet material is shaped so that the longitudinal edges overlap when the composite sheet material is located over the pre-preg, the longitudinal edges fusing together during curing such that no join is visible.

15. The method claim 10, wherein the pre-preg is a thermoset pre-preg.

16. The method of making a composite structure of claim 15, wherein the curing is performed at a temperature of at least 85° C. and less than 165° C.

17. (canceled)

18. The method of claim 10, wherein the plastic material layer is thermoplastic material;
wherein the adhering comprises adhering a thermoplastic pre-preg to the second side of the layer of fibrous material; and
the curing and/or forming comprising thermoforming the thermoplastic pre-preg and the composite sheet material to form the composite structure.

19. (canceled)

20. The method of claim 18, further comprising:
shaping the composite sheet material into a required shape before the adhering of the thermoplastic pre-preg.

21. (canceled)

22. (canceled)

23. (canceled)

24. The method of claim 10, wherein the pre-preg is a thermoset pre-preg and wherein the plastics material layer is formed of thermoplastic material, and the curing of the thermoset pre-preg is performed at a temperature such that a softening point of the thermoplastic material is not exceeded.

25. The method of claim 10, wherein the pre-preg is a carbon fiber pre-preg.

26. A composite sheet material comprising:
a layer of fibrous material, an opaque layer of opaque material and a layer of transparent or translucent plastics material, wherein a first side of the layer of opaque material is coupled to a first side of a layer of fibrous material and the layer of plastics material is located against a second side of the layer of opaque material, wherein the layer of fibrous material comprises at least one of: carbon fibers, fiberglass, aramid, polypropylene and boron,
wherein the second side of the opaque layer of opaque material is viewable through the layer of plastics material, and
wherein the opaque layer is a different color to the color of the fibrous material and the opaque layer and the layer of plastics material cooperate to provide the composite sheet material with a colored appearance,
wherein the first side of the layer of fibrous material is textured and contours of the second side of the opaque material correspond to the shape of the first side of the layer of fibrous material.

27. (canceled)

28. (canceled)

29. (canceled)

30. (canceled)

31. (canceled)

32. (canceled)

33. (canceled)

34. (canceled)

35. A composite structure comprising:
the composite sheet material of claim 26;
a composite material adhered to a second side of the composite sheet material, wherein the composite material has been located against the second side as a pre-preg material and the composite material and the composite sheet material have been cured and/or formed together to form the composite structure.

36. (canceled)

37. (canceled)

38. A method of making a composite structure, comprising:
adhering a pre-preg to the composite sheet material of claim 26, wherein the adhering is to a second side of the fibrous layer, and
curing and/or forming the pre-preg and the composite sheet material to form the composite structure.

39. (canceled)

40. (canceled)

41. (canceled)

42. (canceled)

43. (canceled)

44. (canceled)

45. (canceled)

46. (canceled)

47. (canceled)
